(19) United States
(12) Patent Application Publication
(10) Pub. No.: US 2026/0158759 A1
(43) Pub. Date: Jun. 11, 2026

(54) PRESSURE APPLYING DEVICE

(71) Applicant: EAGLE INDUSTRY CO., LTD., Tokyo (JP)

(72) Inventors: Yoshihiro OGAWA, Tokyo (JP); Kuniaki MIYAKE, Tokyo (JP); Noriyuki OGAWA, Tokyo (JP)

(21) Appl. No.: 19/127,069

(22) PCT Filed: Nov. 20, 2023
(86) PCT No.: PCT/JP2023/041652

§ 371 Date: May 2, 2025

(30) Foreign Application Priority Data
Nov. 30, 2022 (JP) 2022-191714

(51) Int. Cl. B30B 15/06; B30B 1/38

(52) U.S. Cl. CPC B30B 15/062; B30B 1/38

(57) ABSTRACT

A pressure applying device includes a base body and a movable body that is driven forward and backward relative to the base body to apply pressure to an object to be acted upon, and the pressure applying device further includes an elastic body disposed between a front end surface of the movable body and a pressure applied surface of the object to be acted upon.

### TECHNICAL FIELD

The present invention relates to a pressure applying device, for example, a pressure applying device that applies pressure to an object to be acted upon.

### BACKGROUND ART

There is a cylinder device used as a pressure applying device that applies pressure to an object to be acted upon using the pressure of a fluid, and a piston can apply pressure to the object to be acted upon by receiving the pressure of the fluid and moving inside a cylinder.

For example, a pressure applying device of Patent Citation 1 includes a cylinder device, a pump, and an accumulator. When a pressurized fluid is supplied to the cylinder device from the pump or the accumulator, a piston moves relative to a cylinder inside the cylinder to apply pressure to an object to be acted upon.

### CITATION LIST

### Patent Literature

Patent Citation 1: JP 2021-20224 A (Page 5, FIG. 1)

### SUMMARY OF INVENTION

### Technical Problem

In the pressure applying device of Patent Citation 1, a plunger tip is attached to a tip of a rod of the piston, the plunger tip having a larger diameter than the rod. The plunger tip stably applies pressure to the pressure applied surface of the object to be acted upon over a wide area. Meanwhile, from the viewpoint of installation space and weight, it is necessary to reduce the thickness of the plunger tip. However, when the thickness of the plunger tip is reduced, the plunger tip may be locally deformed by the pressure of the pressurized fluid, leading to uneven distribution of surface pressure.

This may result in the relative tilt between the object to be acted upon and the piston, so that pressure cannot be stably applied to the object to be acted upon.

The present invention has been made in view of such problems, and an object of the present invention is to provide a pressure applying device capable of applying pressure while suppressing uneven distribution of surface pressure on a pressure applied surface of an object to be acted upon.

### Solution to Problem

In order to solve the foregoing problems, a pressure applying device according to the present invention includes a base body; a movable body that is driven forward and backward relative to the base body to apply pressure to an object to be acted upon; and an elastic body disposed between a front end surface of the movable body and a pressure applied surface of the object to be acted upon. According to the aforesaid feature of the present invention, the stress acting on the front end surface of the movable body can be dispersed by the elastic body, so that pressure can be applied while suppressing uneven distribution of surface pressure on the pressure applied surface of the object to be acted upon.

It may be preferable that the pressure applying device further includes a pressure plate disposed between the elastic body and the pressure applied surface. According to this preferable configuration, pressure can be stably applied while efficiently suppressing uneven distribution of surface pressure.

It may be preferable that the pressure applying device further includes a locking portion locking the front end surface of the movable body and the pressure plate. According to this preferable configuration, excessive separation between the front end surface of the movable body and the pressure plate can be restricted, so that the elastic body is not affected.

It may be preferable that a closed space is formed to be closed between the front end surface of the movable body and the pressure plate, and the elastic body is disposed within the closed space. According to this preferable configuration, the elastic body can be prevented from leaking out of the closed space when pressure is applied, and the pressure force can be efficiently transmitted to the pressure applied surface.

It may be preferable that the movable body is driven forward and backward in accordance with pressure of gas in a pressure space provided between the movable body and the base body. According to this preferable configuration, even if the pressure of the gas in the pressure space fluctuates, pressure can be applied while suppressing uneven distribution of surface pressure on the pressure applied surface of the object to be acted upon.

It may be preferable that the movable body includes a front end plate portion that is thicker at a central portion than at an outer edge portion. According to this preferable configuration, even if the stress is applied to the front end plate portion, the front end plate portion is deformed evenly, and pressure can be applied while suppressing uneven distribution of surface pressure on the pressure applied surface.

### BRIEF DESCRIPTION OF DRAWINGS

FIG. 1 is a longitudinal sectional view illustrating a contracted state of a pressure applying device according to a first embodiment of the present invention.

FIG. 2 is a longitudinal sectional view illustrating an extended state of the pressure applying device in the first embodiment.

FIG. 3 is a longitudinal sectional view in the contracted state of the pressure applying device, illustrating the vicinity of a pressure applying section in the first embodiment.

FIG. 4 is a longitudinal sectional view illustrating a pressure applying device according to a second embodiment of the present invention.

FIG. 5 is a longitudinal sectional view illustrating a pressure applying device according to a third embodiment of the present invention.

FIG. 6 is a longitudinal sectional view illustrating a pressure applying device according to a fourth embodiment of the present invention.

### DESCRIPTION OF EMBODIMENTS

Modes for implementing a pressure applying device according to the present invention will be described below based on embodiments.

### First Embodiment

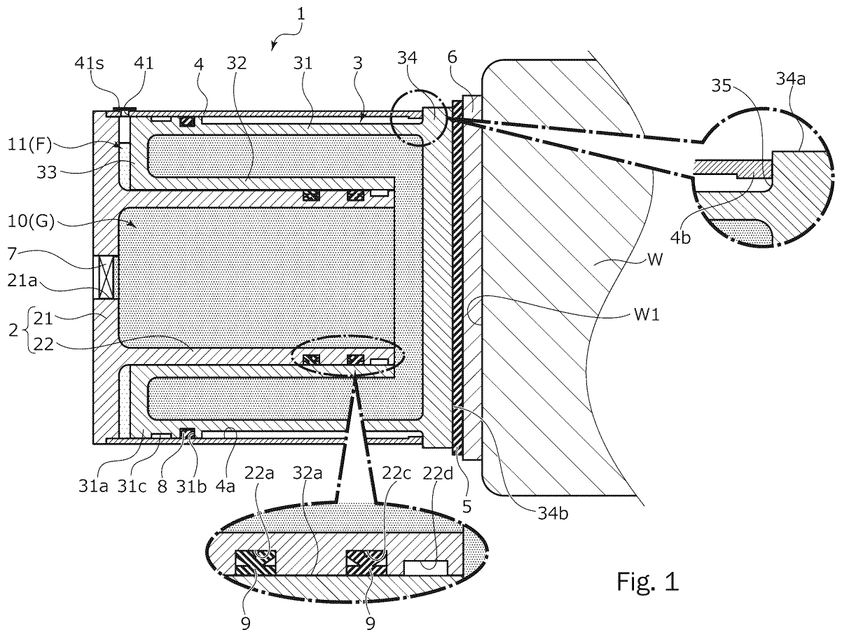

A pressure applying device according to a first embodiment of the present invention will be described with reference to FIGS. 1 to 3. Hereinafter, the description will be made based on the assumption that the right side (sometimes referred to as the front end surface side) of the drawing sheet of FIG. 1 is a right side of the pressure applying device and the left side of the drawing sheet of FIG. 1 is a left side (sometimes referred to as the back surface side) of the pressure applying device. In addition, the description will be made based on the assumption that the top and bottom of the drawing sheet of FIG. 1 is a top and bottom of the pressure applying device.

As illustrated in FIG. 1, a pressure applying device 1 applies pressure to an object W to be acted upon using the pressure of a fluid. The description will be made based on the assumption that the object W to be acted upon of the present embodiment is disposed on the right side of the pressure applying device 1 and the position of a pressure applied surface W1 changes in an axial direction, namely, a left-right direction of the drawing sheet of FIG. 1 depending on the state of use.

Incidentally, in this embodiment, a mode in which the pressure applying device 1 applies pressure to the object W to be acted upon using the pressure of a fluid has been provided as an example; however, for example, a mode in which the pressure applying device applies pressure to the object W to be acted upon using electric drive or the like may be also possible.

The pressure applying device 1 mainly includes a base body 2, a movable body 3, a tubular body 4 as a guide body, an elastic body 5, and a pressure plate 6.

The base body 2 includes a large-diameter portion 21 and a small-diameter portion 22. The large-diameter portion 21 has a disk shape and has a through-hole 21a formed at its central portion. A plug 7 is attached to the through-hole 21a.

The small-diameter portion 22 has a cylindrical shape and extends toward the right side from the central portion of the large-diameter portion 21. The left end portion of the small-diameter portion 22 is closed by the large-diameter portion 21, and the right end portion thereof is open to the right side.

Annular recessed portions 22a, 22c, and 22d recessed in a radially inward direction are provided spaced apart from each other in the axial direction on an outer peripheral surface of the right end portion of the small-diameter portion 22.

The leftmost annular recessed portion 22a and the central annular recessed portion 22c are formed to be deeper than the rightmost annular recessed portion 22d. In addition, a seal ring 9 is fitted and disposed in each of the annular recessed portion 22a and the annular recessed portion 22c.

Incidentally, although the seal ring 9 is not fitted into the annular recessed portion 22d, a bearing member called a wear ring may be installed therein depending on the application.

The seal ring 9 may be of any type such as an X-ring, an O-ring, and a lip seal. Further, since a plurality of the seal rings 9, specifically, two seal rings 9 are disposed in the axial direction, there is almost no oil leakage to a pressure accumulating portion 10 as will be described later, and the movable body 3 is less likely to tilt during movement of the movable body 3.

In addition, when the annular recessed portion 22d is a space, the annular recessed portion 22d has a gas reservoir function and an oil reservoir function. Accordingly, the base body 2 and the movable body 3 can prevent gas leakage and smoothly slide relative to each other. Incidentally, when the wear ring is installed in the annular recessed portion 22d, the wear ring can prevent galling, reduce eccentricity, and improve durability of the seal ring.

The seal rings 9 are slidable in the axial direction with respect to an inner peripheral surface 32a of the movable body 3, and restrict movement of the fluid in the axial direction.

The movable body 3 includes a radially outer side tubular portion 31, a radially inner side tubular portion 32, a back plate portion 33, and a front end plate portion 34.

The radially outer side tubular portion 31 has a larger diameter than the radially inner side tubular portion 32, and is disposed spaced apart from the radially inner side tubular portion 32 toward a radially outer side.

Annular recessed portions 31b and 31c recessed in a radially inward direction are provided spaced apart from each other in the axial direction on an outer peripheral surface of a flange 31a of a left end portion of the radially outer side tubular portion 31, the flange extending toward a radially outer side. A seal ring 8 is fitted and disposed in the annular recessed portion 31b on the right side. The annular recessed portion 31c on the left side is shallower than the annular recessed portion 31b, and the seal ring 8 is not fitted into the annular recessed portion 31c, however a wear ring may be installed in the annular recessed portion 31c depending on the application.

The seal ring 8 may be of any type such as an O-ring, an X-ring, and a lip seal. In addition, the annular recessed portion 31c has an oil reservoir function. Accordingly, the movable body 3 can slide smoothly. Incidentally, the annular recessed portion 31c may be provided at any axial position on the outer peripheral surface of the flange 31a as long as slidability can be enhanced.

The radially inner side tubular portion 32 is concentric with the radially outer side tubular portion 31 when viewed in the axial direction. The radially inner side tubular portion 32 is shorter in the axial direction than the radially outer side tubular portion 31.

The back plate portion 33 couples a left end of the radially outer side tubular portion 31 and a left end of the radially inner side tubular portion 32 and has an annular shape when viewed in the axial direction. The back plate portion 33 extends in a radial direction orthogonally to a central axis of the radially outer side tubular portion 31 and the radially inner side tubular portion 32.

The front end plate portion 34 has a larger rectangular shape than the radially outer side tubular portion 31 when viewed in the axial direction and closes the right end of the radially outer side tubular portion 31. In addition, the front end plate portion 34 is spaced apart from the right end of the radially inner side tubular portion 32 in the axial direction.

In addition, a joint 35 between the front end plate portion 34 and the radially outer side tubular portion 31 has a rounded shape at an outer peripheral surface having a curved surface that is recessed toward a radially inner side in a cross-sectional view. Incidentally, in this embodiment, a portion of the front end plate portion 34 that projects toward the radially outer side from the radially outer side tubular portion 31 is referred to as a step portion 34a.

In addition, the front end plate portion 34 has a thin plate shape. Accordingly, the movable body 3 can have a small axial size and achieve a large stroke in a small installation space.

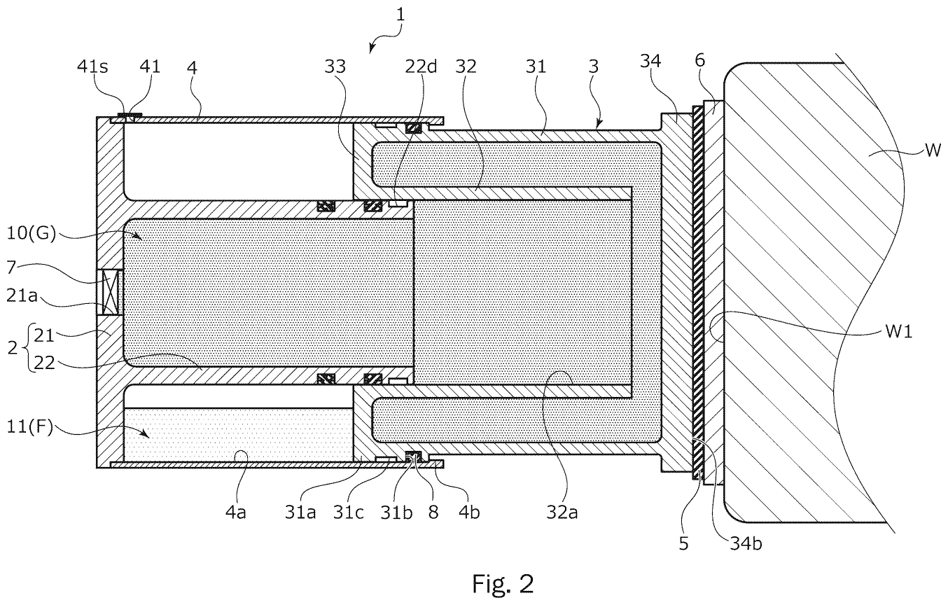

The small-diameter portion 22 of the base body 2 is inserted into the inside of the radially inner side tubular portion 32 of the movable body 3 so as to be relatively movable. Accordingly, the pressure accumulating portion 10 is formed as a pressure space between the base body 2 and the movable body 3. The volume of the pressure accumulating portion 10 changes as the movable body 3 moves as will be described later (see FIG. 2).

High-pressure gas G from the outside through a gas introduction port (not illustrated) of the plug 7 is sealed in the pressure accumulating portion 10. In other words, the pressure accumulating portion 10 is a cylinder-shaped gas chamber.

The left end portion of the tubular body 4 is connected and fixed to the outer peripheral surface of the large-diameter portion 21 of the base body 2. The tubular body 4 has an inner peripheral surface 4a that is relatively slidable in the axial direction with respect to the outer peripheral surface of the flange 31a of the movable body 3. The seal ring 8 restricts movement of fluid in the axial direction between the inner peripheral surface 4a of the tubular body 4 and the outer peripheral surface of the flange 31a of the movable body 3.

A space portion 11 is formed on the left side of the pressure applying device 1 by the base body 2, the movable body 3, and the tubular body 4. Oil F as a lubricating fluid is held in the space portion 11. The volume of the space portion 11 changes as the movable body 3 moves as will be described later (see FIG. 2).

A breathing hole 41 is formed at an upper left portion of the tubular body 4. Namely, the space portion 11 is in communication with the external atmospheric space through the breathing hole 41.

In addition, referring to FIG. 1, an end portion 4b on the right side of the tubular body 4 projects toward a radially inner side. As will be described later, when the movable body 3 has moved to a leftmost position, the end portion 4b comes into contact with the step portion 34a of the movable body 3. In addition, referring to FIG. 2, when the movable body 3 has moved to a rightmost position, the end portion 4b comes into contact with the flange 31a of the movable body 3.

The elastic body 5 is a sheet-shaped rubber material having a hardness of durometer A30. The elastic body 5 has a rectangular shape when viewed in the axial direction, and is formed to be larger than the outer shape of a front end plate portion 34 of the movable body 3. The back surface of the elastic body 5 is fixed to a front end surface 34b of the front end plate portion 34 with an adhesive or the like.

Incidentally, the elastic body 5 has a hardness of preferably durometer A50 or less, more preferably durometer A30 or less. Namely, the elastic body 5 preferably has a low hardness. Incidentally, the material of the movable body 3 may be freely selected as long as the movable body 3 is harder than the elastic body 5.

The pressure plate 6 is made of metal and is formed to be larger than the outer shape of the elastic body 5. The back surface of the pressure plate 6 is fixed to a front end surface of the elastic body 5 with an adhesive or the like. In addition, the front end surface of the pressure plate 6 is in surface contact with the pressure applied surface W1 of the object W to be acted upon. Incidentally, the material of the pressure plate 6 is not limited to metal, and may be freely changed to a resin or the like as long as the pressure plate 6 is harder than the elastic body 5.

Next, the contracted state and the extended state of the pressure applying device 1 will be described using FIGS. 1 and 2. Incidentally, the base body 2 is fixed to a fixed body (not illustrated), and is immovable at least in the axial direction, namely, the left-right direction.

As illustrated in FIG. 1, in a state where the object W to be acted upon is disposed at the leftmost position, the pressure applying device 1 is in the contracted state where the movable body 3 has moved to the leftmost position. When the pressure applying device 1 is in the contracted state, the step portion 34a of the movable body 3 comes into contact with the end portion 4b of the tubular body 4, specifically the right end thereof, and the movement of the movable body 3 toward the left side is restricted.

When the pressure applying device 1 is in the contracted state, the volume of the pressure accumulating portion 10 is at its smallest within the stroke range of the movable body 3, and the gas G is in the most compressed state. The movement of the gas G toward the space portion 11 on the left side is restricted by the two seal rings 9.

The pressure of the gas G in the pressure accumulating portion 10 acts to move the movable body 3 toward the right side.

In addition, when the pressure applying device 1 is in the contracted state, the breathing hole 41 of the tubular body 4 is disposed on the left side with respect to the movable body 3. Namely, the breathing hole 41 is not closed.

Further, a water-repellent ventilation sheet 41s is installed to close the breathing hole 41, and allows gas to flow while preventing water from entering the space portion 11 from the outside and preventing oil from leaking from the space portion 11.

In addition, the liquid level of the oil F is located in the vicinity of a bottom of the breathing hole 41. Accordingly, the oil F is supplied to a gap between the outer peripheral surface of the small-diameter portion 22 of the base body 2 and the inner peripheral surface 32a of the movable body 3, and the oil F does not leak from the breathing hole 41 to the atmospheric space.

As illustrated in FIG. 2, in a state where the pressure applied surface W1 of the object W to be acted upon is disposed at a rightmost position, the pressure applying device 1 is in the extended state where the movable body 3 has moved to the rightmost position. When the pressure applying device 1 is in the extended state, the flange 31a of the movable body 3, specifically the right end surface thereof, comes into contact with the end portion 4b of the tubular body 4, specifically the left end surface thereof, and the movement of the movable body 3 toward the right side is restricted.

When the pressure applying device 1 is in the extended state, the volume of the pressure accumulating portion 10 is at its largest within the stroke range of the movable body 3, and the pressure of the gas G has decreased.

In addition, when the pressure applying device 1 is in the extended state, the movable body 3 moves in a direction separated from the breathing hole 41, namely, toward the right side compared to when the pressure applying device 1 is in the contracted state, so that the breathing hole 41 is not closed. In addition, the liquid level of the oil F is located below the inner peripheral surface 32a of the radially inner side tubular portion 32 of the movable body 3.

Next, a description will be given of the stroke of the movable body 3. The movable body 3 strokes according to the position of the pressure applied surface W1 of the object W to be acted upon. Specifically, when the object W to be acted upon moves toward the right side, the compressed gas G expands and the movable body 3 moves toward the right side relative to the base body 2 following the object W to be acted upon. In addition, when the object W to be acted upon moves toward the left side, the movable body 3, which is pressed by the object W to be acted upon, follows the object W to be acted upon, and moves toward the left side relative to the base body 2 while compressing the gas G. In such a manner, the movable body 3 can stroke according to the position of the pressure applied surface W1 to continue applying pressure to the object W to be acted upon in the axial direction regardless of the position of the object W to be acted upon.

In addition, when the movable body 3 strokes, as illustrated in FIG. 1, if the volume of the space portion 11 is small and the liquid level of the oil F reaches the inner peripheral surface 32a of the radially inner side tubular portion 32, the oil F is supplied to the gap between the outer peripheral surface of the small-diameter portion 22 and the inner peripheral surface 32a of the radially inner side tubular portion 32.

In addition, as illustrated in FIG. 2, when the volume of the space portion 11 is large and the liquid level of the oil F is separated from the inner peripheral surface of the radially inner side tubular portion 32, the oil F remaining in the annular recessed portion 22d contributes to lubricity of the stroke of the movable body 3.

In addition, the oil F in the space portion 11 also enters the gap between the outer peripheral surface of the flange 31a of the radially outer side tubular portion 31 and the inner peripheral surface of the tubular body 4 and is held in the annular recessed portion 31c, contributing to lubricity of the stroke of the movable body 3.

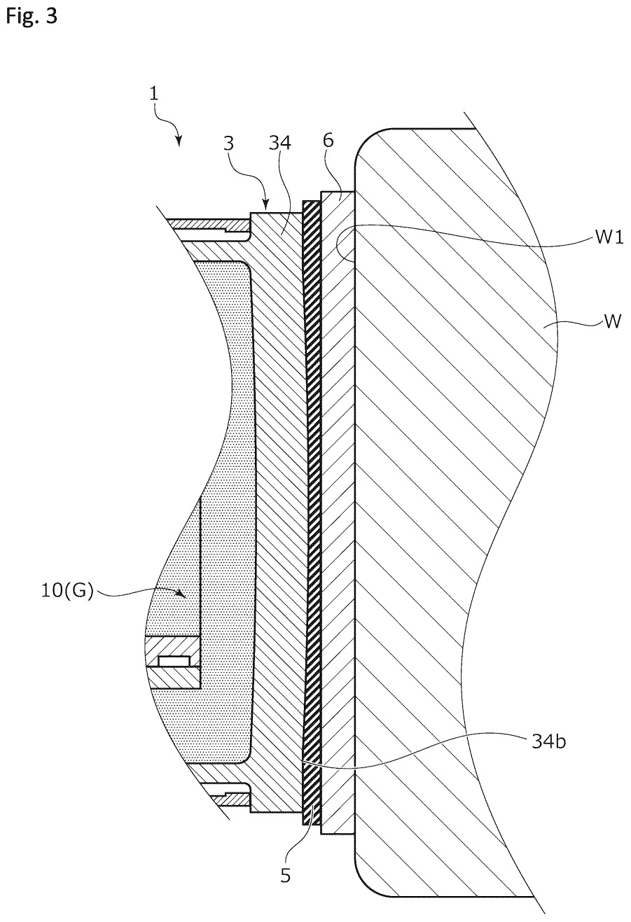

Next, the state of the vicinity of the front portion of the movable body 3 when the pressure applying device 1 is in a contracted state will be described with reference to FIG. 3.

As illustrated in FIG. 3, when the pressure applying device 1 is in the contracted state, the gas G in the pressure accumulating portion 10 is in the most compressed state. As described above, since the front end plate portion 34 of the movable body 3 is formed in a thin plate shape from the viewpoint of installation space, the central portion thereof may bulge toward the right side due to the pressure of the gas G. Incidentally, in FIG. 3, for convenience of explanation, the deformation of the front end plate portion 34 is illustrated to be larger than it actually is.

The stress acting on the front end plate portion 34 of the movable body 3 is dispersed in a surface direction by the elastic body 5 disposed between the front end plate portion 34 and the pressure plate 6, and is transmitted with a substantially uniform surface pressure to the object W to be acted upon via the pressure plate 6. Namely, pressure can be applied while suppressing uneven distribution of surface pressure on the pressure applied surface W1 of the object W to be acted upon. Accordingly, the relative tilt between the front end surface of the pressure plate 6 and the pressure applied surface W1 of the object W to be acted upon is restricted.

In addition, the elastic body 5 is formed larger than the outer shape of the front end plate portion 34 of the movable body 3. In other words, the elastic body 5 covers the entire front end surface 34b of the front end plate portion 34, so that the front end surface 34b of the movable body 3 does not come into direct contact with the pressure plate 6, and thus pressure can be applied to the object W to be acted upon while suppressing uneven distribution of surface pressure.

In addition, the pressure plate 6, which is harder than the elastic body 5 and has the front end surface in surface contact with the pressure applied surface W1 of the object W to be acted upon, is disposed between the elastic body 5 and the pressure applied surface W1. The pressure plate 6 transmits the force dispersed by the elastic body 5 to the pressure applied surface W1 with substantially uniform surface pressure, so that pressure can be applied while further suppressing uneven distribution of surface pressure on the pressure applied surface W1.

In addition, the movable body 3 is driven forward and backward by the pressure of the pressure accumulating portion 10. Even if the pressure in the pressure accumulating portion 10 fluctuates, due to the action of the elastic body 5 as described above, pressure can be applied while suppressing uneven distribution of surface pressure on the pressure applied surface W1 of the object W to be acted upon.

### Second Embodiment

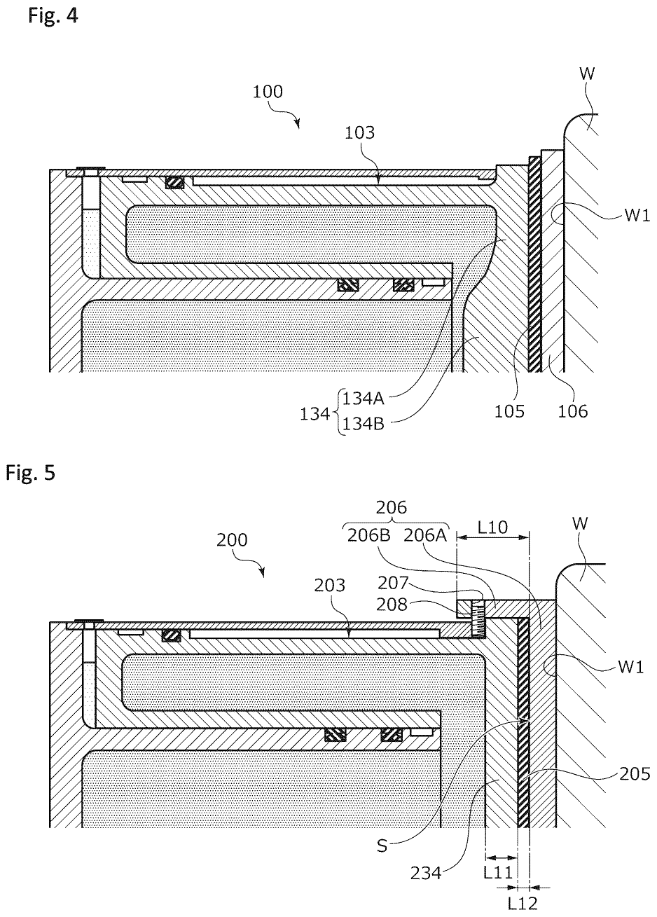

Next, a pressure applying device according to a second embodiment of the present invention will be described with reference to FIG. 4. Incidentally, the description of configurations that are the same as and overlap with the configurations of the first embodiment will be omitted.

As illustrated in FIG. 4, a front end plate portion 134 of a movable body 103 of a pressure applying device 100 according to the second embodiment includes an outer edge portion 134A and a central portion 134B. The central portion 134B is a portion that is thicker than the outer edge portion 134A so that it bulges toward the left side at the central portion of the front end plate portion 134, namely, toward the opposite side of the pressure applied surface W1, and has a protruded shape in a cross-sectional view. In addition, the outer edge portion 134A is a portion of the front end plate portion 134 other than the central portion 134B, and is substantially parallel to a pressure plate 106.

An elastic body 105 is disposed between the front end plate portion 134 of the movable body 103 and the pressure plate 106 without any gaps.

Accordingly, since the central portion 134B is thicker than the outer edge portion 134A, the central portion 134B has high rigidity. Even if force is applied to the front end plate portion 134 due to an increase in pressure in the pressure accumulating portion 10, the front end plate portion 134 is deformed evenly, and the pressure applied to the elastic body can be transmitted evenly, and the pressure force can be efficiently transmitted to the pressure applied surface W1.

### Third Embodiment

Next, a pressure applying device according to a third embodiment of the present invention will be described with reference to FIG. 5. Incidentally, the description of configurations that are the same as and overlap with the configurations of the first embodiment will be omitted.

As illustrated in FIG. 5, a pressure plate 206 of a pressure applying device 200 according to the third embodiment has a tubular shape with a bottom. Specifically, the pressure plate 206 includes a bottom plate portion 206A and a tubular portion 206B extending toward the left side from the outer edge of the bottom plate portion 206A. The pressure plate 206 is fitted onto a front end plate portion 234 of a movable body 203 from the right side.

The tubular portion 206B has an inner peripheral surface slidable on an outer peripheral surface of the front end plate portion 234. The elastic body 205 is disposed without any gaps within a closed space S formed to be substantially closed between the front end plate portion 234 of the movable body 203 and the pressure plate 206. Namely, the closed space S is a closed space isolated from the outside space, and needless to say, it is not limited to only a space in which fluid cannot flow between the closed space and the outside space.

In addition, the tubular portion 206B is formed such that an axial length L10 thereof is longer than the sum of an axial length L11 (namely, thickness L11) of the front end plate portion 234 and an axial length L12 (namely, thickness L12) of the elastic body 205 (L10>L11+L12).

A plurality of screw holes 207 are formed in a circumferential direction of the tubular portion 206B. Screws 208 as locking portions are screwed into the screw holes 207 from the radially outer side.

The screws 208 screwed into the screw holes 207 come into contact with the back surface of the front end plate portion 234. Accordingly, the separation between the front end plate portion 234 and the pressure plate 206 is restricted.

Accordingly, the screws 208 can restrict excessive separation between the front end plate portion 234 of the movable body 203 and the pressure plate 206, so that the elastic body 205 is not affected. For example, even if the front end plate portion 234 deforms, the distance between the front end plate portion 234 and the pressure plate 206 is maintained by the screws 208, thereby preventing separation of the contact surfaces between the front end plate portion 234 and the elastic body 205, as well as the contact surfaces between the elastic body 205 and the pressure plate 206. In addition, the relative tilt between the front end plate portion 234 and the bottom plate portion 206A of the pressure plate 206 is restricted, so that pressure can be applied while suppressing uneven distribution of surface pressure on the pressure applied surface W1 of the object W to be acted upon.

In addition, since the elastic body 205 is disposed within the closed space S, the elastic body 205 can be prevented from leaking out of the closed space S when pressure is applied, and the pressure force can be efficiently transmitted to the pressure applied surface W1.

Incidentally, in the third embodiment, the screws 208 are exemplified as locking portions, however the present invention is not limited thereto, and this may be freely changed. For example, the front end plate portion and the pressure plate may be clamped in the axial direction by a clamp or the like.

### Fourth Embodiment

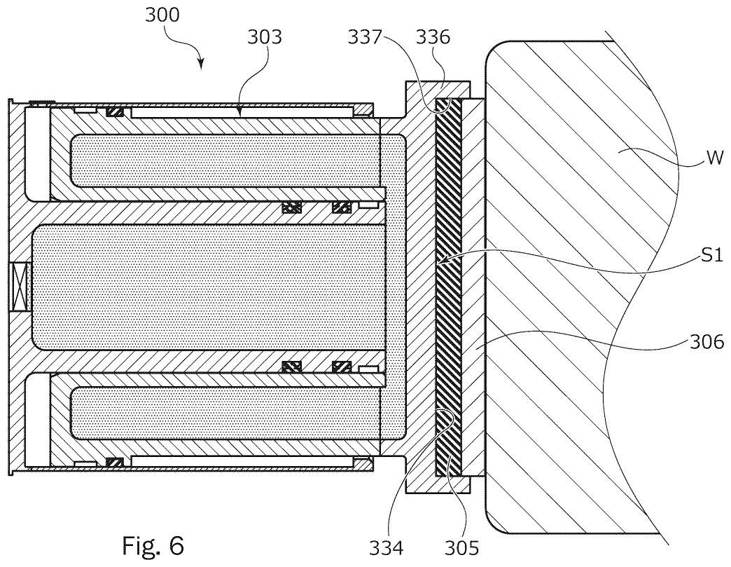

Next, a pressure applying device according to a fourth embodiment of the present invention will be described with reference to FIG. 6. Incidentally, the description of configurations that are the same as and overlap with the configurations of the first embodiment will be omitted.

A movable body 303 of a pressure applying device 300 according to the fourth embodiment is provided with an edge portion 336 that protrudes toward the right side from an outer edge of a front end plate portion 334. Namely, on the right side of the movable body 303, a recessed portion 337 that opens to the right side is formed by the front end plate portion 334 and the edge portion 336. The recessed portion 337 has a rectangular shape when viewed in the axial direction.

An elastic body 305 is surrounded by the edge portion 336 and the front end plate portion 334 and is disposed within the recessed portion 337 without any gaps.

A pressure plate 306 is surrounded by the edge portion 336 and the elastic body 305 and is disposed within the recessed portion 337 without any gaps.

Namely, the elastic body 305 is disposed without any gaps within a closed space S1 formed to be substantially closed between the pressure plate 306 and the front end plate portion 334 and edge portion 336 of the movable body 303.

Accordingly, since the elastic body 305 is disposed within the closed space S1, the elastic body 305 can be prevented from leaking out of the closed space S1 when pressure is applied, and the pressure force can be efficiently transmitted to the pressure applied surface W1.

The embodiments of the present invention have been described above with reference to the drawings; however, the specific configurations are not limited to the embodiments, and changes or additions that are made without departing from the scope of the present invention are included in the present invention.

For example, in the first to fourth embodiments, a mode in which the front end plate portion, the pressure plate, and the elastic body are in order of thickness has been provided as an example; however, these thicknesses may be freely changed.

In addition, in the first to fourth embodiments, a mode in which the front end plate portion, the pressure plate, and the elastic body have a rectangular shape when viewed in the axial direction has been provided as an example; however, the present invention is not limited thereto, and for example, they may have a circular shape when viewed in the axial direction.

In addition, in the first to fourth embodiments, a mode in which the pressure applying device includes a pressure plate has been provided as an example; however, the pressure plate does not necessarily have to be provided. For example, the elastic body may be in direct contact with the pressure applied surface.

In addition, in the first to fourth embodiments, a mode in which the elastic body covers the entire front end surface of the movable body has been provided as an example; however, the present invention is not limited thereto, and the elastic body may be provided partially on the front end surface of the movable body. In this case, it is preferable that a plurality of elastic bodies are disposed in a dispersed manner on the front end surface of the movable body.

In addition, in the first to fourth embodiments, a mode in which the elastic body is made of a sheet-shaped rubber material has been provided as an example; however, the present invention is not limited thereto, and the elastic body may be made of any material as long as the stress acting on the front end surface of the movable body can be dispersed, for example, a synthetic resin, or a spring disposed between the front end surface of the movable body and the pressure plate.

In addition, in the first to fourth embodiments, a mode in which the movable body is driven forward and backward relative to the base body by the pressure of the pressure accumulating portion has been provided as an example; however, the present invention is not limited thereto, and the movable body may be driven forward and backward by the pressure of a fluid that is supplied from an external pump, accumulator, or the like.

In addition, in the first to fourth embodiments, a mode in which the gas is pressurized and accumulated in the pressure accumulating portion has been provided as an example; however, a liquid such as oil or a mixture of a liquid and a gas may be sealed in the pressure accumulating portion.

In addition, in the first to fourth embodiments, a mode in which the breathing hole 41 is provided in the tubular body has been provided as an example; however, the breathing hole may not be provided and the pressure change in the space portion 11 in addition to the pressure change in the pressure accumulating portion 10 may be utilized.

### REFERENCE SIGNS LIST

1 Pressure applying device
2 Base body
3 Movable body
5 Elastic body
6 Pressure plate
10 Pressure accumulating portion
11 Space portion
34 Front end plate portion
34b Front end surface
100 Pressure applying device
103 Movable body
105 Elastic body
106 Pressure plate
134 Front end plate portion
200 Pressure applying device
203 Movable body
205 Elastic body
206 Pressure plate
208 Screw (locking portion)
300 Pressure applying device
303 Movable body
305 Elastic body
306 Pressure plate
F Oil
G Gas
S Closed space
W Object to be acted upon
W1 Pressure applied surface

1. A pressure applying device comprising:
a base body;
a movable body that is driven forward and backward relative to the base body to apply pressure to an object to be acted upon; and
an elastic body disposed between a front end surface of the movable body and a pressure applied surface of the object to be acted upon.

2. The pressure applying device according to claim 1, further comprising
a pressure plate disposed between the elastic body and the pressure applied surface.

3. The pressure applying device according to claim 2, further comprising
a locking portion locking the front end surface of the movable body and the pressure plate.

4. The pressure applying device according to claim 2 , wherein
a closed space is formed to be closed between the front end surface of the movable body and the pressure plate, and
the elastic body is disposed within the closed space.

5. The pressure applying device according to claim 1, wherein
the movable body is driven forward and backward in accordance with pressure of gas in a pressure space provided between the movable body and the base body.

6. The pressure applying device according to claim 1, wherein
the movable body includes a front end plate portion that is thicker at a central portion than at an outer edge portion.

7. The pressure applying device according to claim 3, wherein
a closed space is formed to be closed between the front end surface of the movable body and the pressure plate, and
the elastic body is disposed within the closed space.
